(19) United States
(12) Patent Application Publication
(10) Pub. No.: US 2004/0163681 A1
(43) Pub. Date: Aug. 26, 2004

(54) Dilute sulfuric peroxide at point-of-use

(75) Inventor: Steven Verhaverbeke, San Francisco, CA (US)

Correspondence Address: PATENT COUNSEL, APPLIED MATERIALS, INC., Legal Affairs Department, P.O. Box 450A, Santa Clara, CA, 95052, US

(73) Assignee: APPLIED MATERIALS, INC.

(21) Appl. No.: 10/676,182

(22) Filed: Sep. 30, 2003

Related U.S. Application Data
(60) Provisional application No. 60/450,117, filed on Feb. 25, 2003.

(51) Int. Cl. B08B 3/00

(52) U.S. Cl. 134/28

(57) ABSTRACT

Embodiments of the invention generally provide methods for removing a residue from a substrate surface, comprising mixing an aqueous solution with a hydrogen peroxide solution to produce a cleaning solution. The aqueous solution comprises sulfuric acid and hydrofluoric acid. A portion of the cleaning solution is applied to residue and the substrate surface a period. The portion of the cleaning solution is rinsed from the substrate surface with water to form a wash solution. The wash solution is discarded following cleaning of each wafer.

### CROSS-REFERENCE TO RELATED APPLICATIONS

This application claims benefit of U.S. Provisional Patent Application Serial No. 60/450,117, filed Feb. 25, 2003, which is herein incorporated by reference.

### BACKGROUND OF THE INVENTION

1. Field of the Invention

Embodiments of the invention generally relate to a semiconductor cleaning process and are more particularly related to removing residue from the surface of substrates.

2. Description of the Related Art

Cleaning processes used to treat substrate surfaces have evolved along with the requirements of the semiconductor industry. The RCA Standard Clean is one of the earliest known substrate cleaning techniques and generally utilizes a two-step process of treating a surface with an alkaline solution followed by, an acidic solution. The first treatment, known as SC-1, is a mixture of water, hydrogen peroxide and ammonium hydroxide in a 5:1:1 ratio. The second treatment, known as SC-2, is a mixture of water, hydrogen peroxide and hydrochloric acid in a 6:1:1 ratio.

Cleaning processes developed based on the particular surfaces and contaminants and include an assortment of chemical solutions, such as SC-1, SC-2, DI water, piranha or caros (sulfuric acid and hydrogen peroxide), hot nitric acid, aqua regia and concentrated hydrofluoric acid. The chemical solutions are generally dispensed by dipping the substrate into a series of solutions. Often, as many as five chemical solutions are used with a single surface. The resultant surface is particularly sensitive to the order in which the solutions are administered.

Dilute sulfuric peroxide (DSP) is a current cleaning process used to remove post-etch resist from an aluminum surface. DSP is an aqueous based, dilute solution of sulfuric acid and hydrogen peroxide. Though chemically the same as piranha, the dilution of DSP enables a more controlled cleaning process on an aluminum surface.

During typical cleaning processes, the substrate is either dipped into a chemical bath or a chemical mixture is sprayed onto the surface of the substrate. Often, excess chemical mixture that is sprayed-on, drips from the surface of the substrate and is recirculated into the process. The recirculated process is common and suffers several disadvantages including particle contamination within the solution. Particles are recirculated in the chemical mixture to become more prevalent and adhere to the substrate surfaces as the cleaning process progresses through a batch of substrates. Particulate on substrate surfaces damage subsequent layers by reducing adhesion or producing uneven films. Also, as a batch of substrates is cleaned with a recirculated process, the individual chemical concentrations within the mixture does not remain consistent from one substrate to the next, since components are being consumed.

Therefore, there is a need for a DSP process to clean substrates, in which a chemical solution is maintained with a consistent concentration from one substrate to another. Also, particles removed from one substrate should not contaminate subsequent substrates.

### SUMMARY OF THE INVENTION

In one embodiment, the invention generally provides a method for removing a residue from a substrate surface, comprising mixing an aqueous solution including sulfuric acid and hydrofluoric acid with a hydrogen peroxide solution to produce a cleaning solution. The method further comprises applying an aliquot of the cleaning solution to the residue and the substrate surface for a period and rinsing the aliquot from the substrate surface with water to form a wash solution. The wash solution remains isolated from the cleaning solution.

Another embodiment of the invention generally provides a method for cleaning a residue from a substrate surface via a single pass of an aliquot of a cleaning solution, comprising exposing the substrate surface to the aliquot, rinsing the substrate surface with a water to remove the residue and the aliquot, forming a wash solution comprising the water, the residue and the aliquot and disposing of the wash solution to complete the single pass. The cleaning solution comprises sulfuric acid, hydrogen peroxide and hydrofluoric acid.

Another embodiment of the invention generally provides a method of mixing and dispersing a cleaning solution to remove a residue from a substrate surface. The method further comprises providing an aqueous solution comprising sulfuric acid and hydrofluoric acid, combining the aqueous solution and a hydrogen peroxide solution in a mixing vessel to form the cleaning solution, transferring the cleaning solution to the residue and the substrate surface, removing at least a portion of the residue from the substrate surface via the cleaning solution, and rinsing the substrate surface to remove the cleaning solution.

### DETAILED DESCRIPTION OF THE PREFERRED EMBODIMENT

The present invention discloses processes to clean residue from the surface from a substrate. Generally, a cleaning solution is sprayed onto a substrate surface, rinsed off the substrate along with the contaminants and collected for disposal. Cleaning solutions include a mixture of water (H₂O), sulfuric acid (H₂SO₄), hydrofluoric acid (HF), hydrogen peroxide (H₂O₂) and optional surfactant.

Residues remain on the substrate surface post etching processes and are removed using cleaning solutions. The post aluminum etch process produces residues that are generally inorganic, such as aluminum oxides and silicon oxides (e.g., Al₂O₃ and SiO₂). After via patterning and/or O₂ plasma dry etch, the residues have some metal oxides, but mostly contain carbon-based or silicon-based polymeric contaminants.

In one embodiment of the process, a hydrogen peroxide solution is combined in a mixing vessel with an aqueous solution containing sulfuric acid and hydrofluoric acid. In some embodiments, the aqueous solution contains a surfactant. The aqueous solution and the hydrogen peroxide solution contain water, while water can also be directly added to the cleaning solution or during the mixing of the cleaning solution. The cleaning solution is applied to the substrate to remove surface debris, such as residue and/or particulates. A wash solution is formed from remnant cleaning solution off the surface of the substrate, debris and any rinse water. The wash solution is generally disposed as waste material.

The wash solution is not recirculated with the cleaning solution. Instead, the substrate may be exposed to virgin cleaning solution in a process called single pass cleaning. Recirculated cleaning processes blend the wash solution with the cleaning solution in a continuous loop. Single pass cleaning processes are advantageous for several reasons, including the absence of recirculated debris within the cleaning solution. Though some recirculated processes filter debris from the solution, complete removal of debris, as well as added cost for filtration systems, remain a concern for semiconductor processes. Secondarily, recirculated processes suffer from inconsistent chemical exposure of individual substrates within a batch due to fluctuations with the chemical concentration of the cleaning solution from one substrate to another. Therefore, a single pass cleaning process exposes a substrate to a debris-free, chemical mixture with a consistent chemical concentration.

In one embodiment, an aqueous solution includes sulfuric acid, hydrofluoric acid and water. For example, an aqueous solution may include, by weight, sulfuric acid (about 67%), water (about 33%) and hydrofluoric acid (about 0.17%). The hydrogen peroxide solution includes hydrogen peroxide and water. For example, a hydrogen peroxide solution may include, by weight, hydrogen peroxide (about 8%) and water (about 92%). The aqueous solution and the hydrogen peroxide solution are combined at various weight ratios to form the cleaning solution containing the desired concentration of each chemical component. In one example, the aqueous solution and the hydrogen peroxide solution may be combined 1:20 to form the cleaning solution. In one embodiment, further dilution of a clean solution with water may occur during or after the combining of an aqueous solution and a hydrogen peroxide solution.

The cleaning solution includes a mixture of water, sulfuric acid, hydrofluoric acid and hydrogen peroxide. In one embodiment, the sulfuric acid concentration of the cleaning solution is in the range from about 0.5% to about 25%, preferably from about 1% to about 10% and more preferably from about 2% to about 5% by weight. The hydrogen peroxide concentration of the cleaning solution is in the range from about 0.5% to about 25%, preferably from about 1% to about 15% and more preferably from about 5% to about 10% by weight. The hydrogen fluoride concentration of the cleaning solution is in the range from about 1 ppm to about 10,000 ppm, preferably from about 10 ppm to about 1,000 ppm and more preferably from about 50 ppm to about 500 ppm. The water concentration of the cleaning solution is in the range from about 50% to about 99%, preferably from about 75% to about 97% and more preferably from about 85% to about 95% by weight.

The cleaning solution removes residues from aluminum wafers by utilizing each chemical component within the solution. Sulfuric acid removes aluminum oxide from the substrate surface. Hydrofluoric acid removes polymeric residues from the substrate surface. Hydrogen peroxide grows a protective layer of aluminum oxide over the aluminum surface to slow the etching of the aluminum by the acids. Therefore, a cleaning solution is adjusted for various substrate surfaces and/or residues by balancing the concentration of these components.

In fabrication facilities, concentrated sulfuric acid (e.g., 98%) is commonly used as a component in various solutions, such as piranha. Concentrated sulfuric acid is very exothermic during the dissociation reaction with water to form diluted sulfuric acid mixtures. For DSP application, the exothermic reaction produces uncontrollable heat in the mixing vessel, which is an undesirable attribute, since heated solutions may need to cool before they are used. In one aspect of the invention, sulfuric acid with a concentration of 70% or less is used as a sulfuric acid source. In one example, an aqueous solution having about 67% H₂SO₄ is combined with a hydrogen peroxide solution to cause a small and manageable increase in temperature (<3° C.) to the resulting cleaning solution.

Some embodiments of the processes use a surfactant within the cleaning solution. Surfactants advantageously emulsify and remove particulates from the surface of the substrate by reducing surface tension of the cleaning solution. Surfactants found useful in the processes include glycol ethers, carboxylic acids, amines, sulfonamides, and fluoroalkylsulfonamides. In one embodiment, the surfactant concentration of the cleaning solution is in the range from about 0.1 ppm to about 1,000 ppm, preferably from about 1 ppm to about 100 ppm and more preferably from about 1 ppm to about 50 ppm. Generally, surfactants are blended into the aqueous solution. For example, an aqueous solution may include about 67% H₂SO₄, about 32% H₂O, about 0.4% HF and about 0.1% surfactant.

Cleaning processes are generally conducted at a temperature in a range from about 15° C. to about 200° C. Many process temperatures are generally conducted at a temperature in a range from about 15° C. to about 80° C. In other embodiments, the process temperature is less than about 100° C. and preferably less than about 50° C. Ambient room temperature (e.g., about 23° C.) has been found to be useful in some embodiments. In some embodiments, exposure to the cleaning solution occurs during a period in a range from about 1 second to about 5 minutes, for example, a period of less than 2 minutes. In another example, the period is about 60 seconds. Some embodiments utilize sonication processes during the cleaning process, such as megasonic and ultrasonic techniques. Sonication processes reduce the amount of particulate from the substrate surface.

In another embodiment of the process, sulfuric acid and hydrogen peroxide are combined to form a foundation solution. Water may be added to the foundation solution depending on the concentration of the sulfuric acid and hydrogen peroxide. Hydrogen fluoride is added to the foundation solution as hydrofluoric acid. Though hydrogen fluoride gas may be bubbled through the foundation solution, enhanced control of the hydrogen fluoride concentration is obtained by the addition of a known concentration of hydrofluoric acid.

Embodiments of the processes clean many residues from substrate surfaces. Residues include resist, polymeric, silicon, silicon oxide, aluminum, aluminum oxide, and particulates of surface matter or substrate matter. Substrates on which embodiments of the invention can be useful include, but are not limited to semiconductor wafers, such as crystalline silicon (e.g., Si<100> and Si<111>), silicon oxide, silicon germanium, aluminum wafers, doped or undoped wafers, and patterned or non-patterned wafers. Surfaces include wafers, films, layers and materials with dielectric, conductive and barrier properties and include polysilicon, silicon on insulators (SOI), strained and unstrained lattices. Substrates usually have a surface containing at least one metal, such as aluminum, titanium, tungsten, tantalum and/or copper. In one aspect, the substrate surface includes metal nitrides (e.g., titanium nitride, tantalum nitride and/or tungsten nitride) or metal oxides (e.g., aluminum oxide). In one embodiment, wafers have an aluminum-containing surface. Optional pretreatment of surfaces includes polishing, etching, reduction, oxidation, hydroxylation, annealing, baking and combinations thereof.

Cleaning processes of the invention are usually conducted post etch steps to remove residue resist or particulate. However, cleaning steps may be utilized to remove debris from substrate surfaces after a variety of semiconductor processes, such as deposition techniques. Deposition techniques include atomic layer deposition (ALD) and chemical vapor deposition (CVD), wherein CVD includes the use of many techniques, such as plasma-assisted CVD (PA-CVD), atomic layer CVD (ALCVD), organometallic or metalorganic CVD (OMCVD or MOCVD), laser-assisted CVD (LA-CVD), ultraviolet CVD (UV-CVD), hot-wire (HWCVD), reduced-pressure CVD (RP-CVD) and ultra-high vacuum CVD (UHV-CVD).

The processes of the invention can be carried out in equipment known in the art for cleaning substrates and include batch or single wafer wet-bench system. The processes can operate at a range of pressures from about 1 mTorr to about 2,000 Torr, but generally at ambient pressure, such as about 760 Torr. Hardware that can be used to clean the surface of substrates includes the Oasis® system equipped with the Tempest® wet clean chamber, both available from Applied Materials, Inc., located in Santa Clara, Calif.

### EXAMPLES

So that the manner in which the above recited features of the present invention can be understood in detail, a more particular description of the invention, briefly summarized above, may be had by reference to embodiments, some of which are demonstrated in the examples. It is to be noted, however, that the examples demonstrate only typical embodiments of this invention and are therefore not to be considered limiting of its scope, for the invention may admit to other equally effective embodiments.

### Example 1

An aluminum coated substrate (300 mm OD) contained particulates (e.g., Al₂O₃ and SiO₂) after an etch process. The substrate was placed into a Tempest® chamber and exposed to a cleaning solution containing, by weight, H₂SO₄ (3.6%), H₂O₂ (7.1%), H₂O (89.3%) and HF (125 ppm). The substrate was sonicated with a megasonicator set at 550 watts. The solution is maintained on the wafer for 60 seconds at room temperature. The cleaning solution and particulates were rinsed with deionized water for 20 seconds. The aluminum on the substrate was slightly etched and lost about 2 nm of thickness while the particulates and photoresist residues were completely removed.

### Example 2

An aluminum coated substrate (300 mm OD) contained particulates (e.g., polymeric) after a via etch. The substrate was placed into a Tempest® chamber and exposed to a cleaning solution containing, by weight, H₂SO₄ (3.6%), H₂O₂ (7.1%), H₂O (89.3%) and HF (250 ppm). The substrate was sonicated with a megasonicator set at 900 watts. The solution is maintained on the wafer for 80 seconds at 50° C. The cleaning solution and particulates were rinsed with deionized water for 30 seconds. The aluminum on the substrate was slightly etched and lost about 5 nm of thickness while the particulates and post via etch residues were completely removed.

While the foregoing is directed to embodiments of the present invention, other and further embodiments of the invention may be devised without departing from the basic scope thereof, and the scope thereof is determined by the claims that follow.

1. A method for removing a residue from a substrate surface, comprising:
mixing an aqueous solution comprising sulfuric acid and hydrofluoric acid with a hydrogen peroxide solution to produce a cleaning solution;
applying an aliquot of the cleaning solution to a substrate surface for a period of time; and
rinsing the aliquot from the substrate surface with water to form a wash solution.

2. The method of claim 1, wherein the wash solution remains isolated from the cleaning solution.

3. The method of claim 1, wherein the cleaning solution comprises a surfactant selected from the group consisting of glycol ethers, carboxylic acids, amines, sulfonamides, and fluoroalkylsulfonamides.

4. The method of claim 3, wherein the surfactant has a surfactant concentration in a range from about 1 ppm to about 100 ppm.

5. The method of claim 1, wherein the residue is selected from the group consisting of resist, polymeric, silicon, silicon oxide, aluminum, aluminum oxide and particulates of surface matter or substrate matter.

6. The method of claim 1, wherein the cleaning solution includes a hydrogen peroxide concentration in a range from about 1% to about 15% by weight.

7. The method of claim 6, wherein the cleaning solution includes a sulfuric acid concentration in a range from about 1% to about 10% by weight.

8. The method of claim 7, wherein the cleaning solution includes a hydrogen fluoride concentration in a range from about 10 ppm to about 1,000 ppm.

9. The method of claim 8, wherein the cleaning solution has a temperature in a range from about 15° C. to about 80° C.

10. The method of claim 9, wherein the period of time is less than 2 minutes.

11. The method of claim 1, wherein-the substrate surface comprises a material selected from the group consisting of aluminum, copper, tungsten, titanium, tantalum, titanium nitride, tantalum nitride, tungsten nitride and combinations thereof.

12. The method of claim 11, wherein the residue comprises a resist and the substrate surface comprises aluminum.

13. The method of claim 1, wherein the cleaning process includes sonication.

14. A method for cleaning a residue from a substrate surface, comprising:
exposing the substrate surface to an aliquot of a cleaning solution comprising sulfuric acid, hydrogen peroxide and hydrofluoric acid;
rinsing the substrate surface with water to remove a residue and the aliquot of the cleaning solution;
forming a wash solution comprising the water, the residue and the aliquot of the cleaning solution; and
discarding of the wash solution.

15. The method of claim 14, wherein the cleaning solution is formed by combining a hydrogen peroxide solution and an aqueous solution.

16. The method of claim 15, wherein the aqueous solution comprise sulfuric acid and hydrofluoric acid.

17. The method of claim 14, wherein the cleaning solution includes a surfactant.

18. The method of claim 17, wherein the surfactant is selected from the group consisting of glycol ethers, carboxylic acids, amines, sulfonamides, and fluoroalkylsulfonamides.

19. The method of claim 18, wherein the surfactant has a surfactant concentration in a range from about 1 ppm to about 100 ppm.

20. The method of claim 14, wherein the residue is selected from the group consisting of resist, polymeric, silicon, silicon oxide, aluminum, aluminum oxide, particulates of surface matter or substrate matter.

21. The method of claim 14, wherein the cleaning solution includes a hydrogen peroxide concentration in a range from about 1% to about 15% by weight.

22. The method of claim 21, wherein the cleaning solution includes a sulfuric acid concentration in a range from about 1% to about 10% by weight.

23. The method of claim 22, wherein the cleaning solution includes a hydrogen fluoride concentration in a range from about 10 ppm to about 1,000 ppm.

24. The method of claim 23, wherein the cleaning solution has a temperature in a range from about 15° C. to about 80° C.

25. The method of claim 24, wherein a single pass of the substrate surface last less than 2 minutes.

26. The method of claim 14, wherein the substrate surface comprises a material selected from the group consisting of aluminum, copper, tungsten, titanium, tantalum, titanium nitride, tantalum nitride, tungsten nitride and combinations thereof.

27. The method of claim 26, wherein the residue comprises a resist and the substrate surface comprises aluminum.

28. The method of claim 14, wherein the cleaning process includes sonication.

29. A method of mixing and delivering a cleaning solution to remove a residue from a substrate surface, comprising:
providing an aqueous solution comprising sulfuric acid and hydrofluoric acid;
combining the aqueous solution and a hydrogen peroxide solution to form the cleaning solution;
delivering the cleaning solution to a substrate surface;
removing at least a portion of a residue from the substrate surface; and
rinsing the substrate surface to remove the cleaning solution.

30. The method of claim 29, wherein the residue is selected from the group consisting of resist, polymeric, silicon, silicon oxide, aluminum, aluminum oxide, particulates of surface matter or substrate matter.

31. The method of claim 30, wherein the cleaning solution includes a hydrogen peroxide concentration in a range from about 1% to about 15% by weight.

32. The method of claim 31, wherein the cleaning solution includes a sulfuric acid concentration in a range from about 1% to about 10% by weight.

33. The method of claim 32, wherein the cleaning solution includes a hydrogen fluoride concentration in a range from about 10 ppm to about 1,000 ppm.

34. The method of claim 33, wherein the cleaning solution has a temperature in a range from about 15° C. to about 80° C.

35. The method of claim 34, wherein the substrate surface comprises a material selected from the group consisting of aluminum, copper, tungsten titanium, tantalum, titanium nitride, tantalum nitride, tungsten nitride and combinations thereof.

36. The method of claim 35, wherein a sonication process is used in the cleaning solution.

37. The method of claim 36, wherein a single pass of the substrate surface last less than 2 minutes.
